(19) United States
(12) Patent Application Publication
(10) Pub. No.: US 2015/0199420 A1
(43) Pub. Date: Jul. 16, 2015

(54) VISUALLY APPROXIMATING PARALLEL COORDINATES DATA

(71) Applicant: Silicon Graphics International, Corp., Milpitas, CA (US)

(72) Inventor: Marc Hansen, Morgan Hill, CA (US)

(73) Assignee: Silicon Graphics International, Corp., Milpitas, CA (US)

(21) Appl. No.: 14/152,969

(22) Filed: Jan. 10, 2014

(51) Int. Cl. G06F 17/30; G06F 3/0484

(52) U.S. Cl. CPC G06F 17/30604; G06F 3/04842

(57) ABSTRACT

A data visualization system with the capability of viewing large amounts of data in a parallel coordinates system. Large amounts of data are displayed in parallel coordinates by grouping together data points by bins and representing grouped data with fewer graphical elements. The fewer graphical elements simplify the graphical representation of the data while still providing information about the density or volume of data occupying a particular space. Bins are determined for each axis. The volume of connections between a pair of neighboring pair of bins may be represented by modifying an aspect of the connection based on the volume.

### BACKGROUND

1. Field of the Invention

The present invention relates to visualization of data. In particular, the present invention relates to multi-dimensional data visualization.

2. Description of the Prior Art

Visualization of data in three dimensional graphs can be helpful to understand the data. An example of a three dimensional graph is a plot of data on multiple axis, such as a three dimensional horizontal, vertical, and another axis coming towards or away from the point of view of a viewer. Three dimensional coordinate graphics are sometimes translated into parallel coordinates. This can be helpful to identify data values in another format, but can quickly become overwhelming with a large number of data points

With big data applications becoming increasingly popular, there is a need to display large amounts of data in multiple formats in order to better understand the relationships of the data. What is needed is an improved visualization interface for displaying data as desired by a user.

### SUMMARY

The present technology may provide data visualization with the capability of viewing large amounts of data in a parallel coordinates system. Parallel coordinates typically display lines between two or more vertical lines representing a coordinate element. When large amounts of data are displayed in parallel coordinates, the graphical display can appear too crowded to make the display useful. Rather than displaying each and every line between coordinate lines, multiple lines may be grouped together and represented with fewer graphical elements. The fewer graphical elements simplify the graphical representation of the data while still providing information about the density or volume of data occupying a particular space. Data groupings such as bins are determined for each axis. The number of data points extending between neighboring parallel coordinates are then identified for each bin. Each neighboring bin pair that includes one or more connecting data point will include a graphical representation, such as a line, that links the two bins. The volume of connections between a pair of bins may be represented by modifying an aspect of the connection based on the volume. For example, when the connection between two bins is represented as a line, the volume of the number of connections may be represented by increasing the width of the line to correspond to the volume of data in the bin pair. Similarly, the volume may be shown by setting the opacity of the line based on the volume of data points in the group pair.

An embodiment may include a method for displaying data. The method may determine a number of groups associated with each coordinate in a parallel coordinate display. A number of data points of a plurality of data points may be identified which corresponds to a pair of groups in a pair of consecutive coordinate axes. A single graphical representation may be displayed between each pair of groups that include at least one data point. The single graphical representation may be based on the volume of data associated with the pair of groups.

An embodiment may include a system for displaying data. The system may include a processor, a memory, and one or more modules stored in memory. The one or more modules may be executed by the processor to determine a number of groups associated with each coordinate in a parallel coordinate display, identify a number of data points of a plurality of data points corresponding to a pair of groups in a pair of consecutive coordinates, and display a single graphical representation between each pair of groups that include at least one data point, the single graphical representation based on the volume of data associated with the pair of groups.

### BRIEF DESCRIPTION OF THE DRAWINGS

FIG. 1 is a system for processing and visualizing data.

FIG. 2 is a method for processing and visualization data.

FIG. 3 is a method for visually approximating data in parallel coordinates.

FIG. 4 illustrates data points in three dimensional x,y,z coordinate system.

FIG. 5 illustrates data points in parallel coordinates.

FIG. 6 illustrates a high volume of data points in three dimensional x,y,z coordinate system.

FIG. 7 illustrates a high volume of data points in parallel coordinates.

FIG. 8 illustrates a first approximation of data points in parallel coordinates.

FIG. 9 illustrates a second approximation of data points in parallel coordinates.

FIG. 10 provides a computing device for implementing the present technology.

### DETAILED DESCRIPTION

The present technology may provide data visualization with the capability of viewing large amounts of data in a parallel coordinates system. Parallel coordinates typically display lines between two or more vertical lines representing a coordinate element. When large amounts of data are displayed in parallel coordinates, the graphical display can appear too crowded to make the display useful. Rather than displaying each and every line between coordinate lines, multiple lines may be grouped together and represented with fewer graphical elements. The fewer graphical elements simplify the graphical representation of the data while still providing information about the density or volume of data occupying a particular space. Bins are determined for each axis. The number of data points extending between neighboring parallel coordinates are then identified for each bin. Each neighboring bin pair that includes one or more connecting data point will include a graphical representation, such as a line, that links the two bins. The volume of connections between a pair of bins may be represented by modifying an aspect of the connection based on the volume. For example, when the connection between two bins is represented as a line, the volume of the number of connections may be represented by increasing the width of the line to correspond to the volume of data in the bin pair. Similarly, the volume may be shown by setting the opacity of the line based on the volume of data points in the bin pair. In some instances, other formatting may be used to communicate an aspect of the data, such as a dotted line or other formatting.

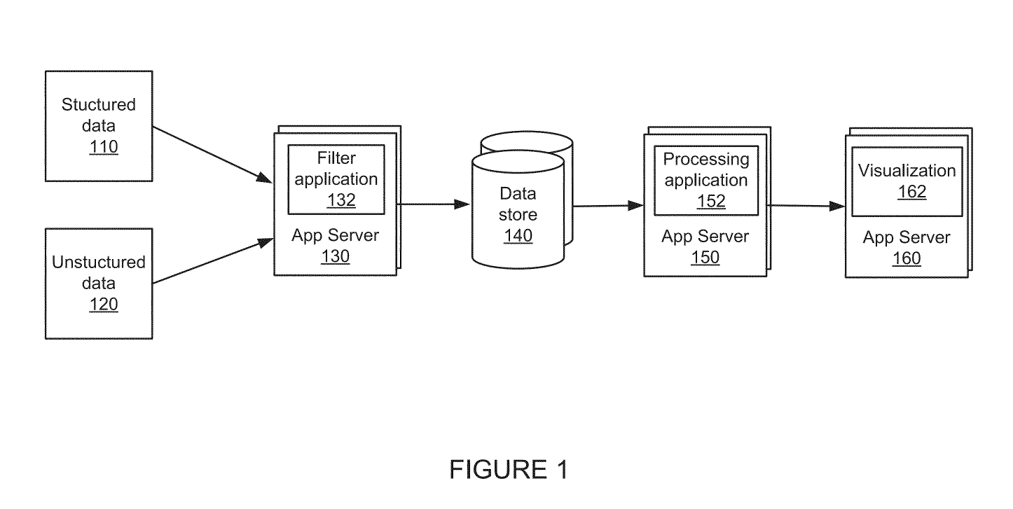

FIG. 1 is a system for processing and visualizing data. The system of FIG. 1 includes structured data 110, unstructured data 120, application servers 130, 150 and 160, and data store 140. Structured data 110 (e.g., RDMS data) may include data items stored in tables. The structured data may be stored in a relational database, and may be formally described and organized according to a relational model. Structured data 110 may be data which can be managed using a relational database management system and may be accessed by application server 130.

Unstructured data may include data that does not include a predefined data model or does not fit into relational tables as structured data 110. Unstructured data may include text, dates, numbers, facts and other data, including email, media and documents. Unstructured data may also include lists or other data associated with web page clicks, shopping cart data, and other data. Unstructured data may be accessed by application server 130.

Application server 130 may include one or more servers which receive and access structured data 110 and unstructured data 120. Filter application 132 may be stored and executed on application server 130, and may be executed to ingest the structured and unstructured data. Filter application 132 may apply filters, intelligence, or other processes to select a subset of the data received and/or accessed.

Data store 140 may include one or more data stores which receive data which has been filtered by filter application 132. Data stores 140 may include SQL servers, NoSQL servers, and other servers. The data may be stored in these servers until they are accessed for processing.

Application server 150 may include one or more servers which receive and/or access data stored in data store 140. Processing application 152 may be stored on application server 150. When executed, processing application 152 may access filtered data from data store 140 and analyze the data for trends, patterns, a particular data of interest, or other data desired for reporting. For example, processing application 152 may be implemented by “Apache Hadoop” software, which is an open source software application which provides a distributed application for analyzing data.

Once data is analyzed, visualization program 162 located on application server 160 may report the data to a user. The data may be provided in many forms, such as reports, visualizations, and other formats. For example, visualization application 162 may provide data in a three dimensional graphical visualization format. In some embodiments, processing application 152 and visualization module 162 may be implemented as part of a client server tool set for extracting data, mining data with analytical algorithms, and providing interactive visualization input.

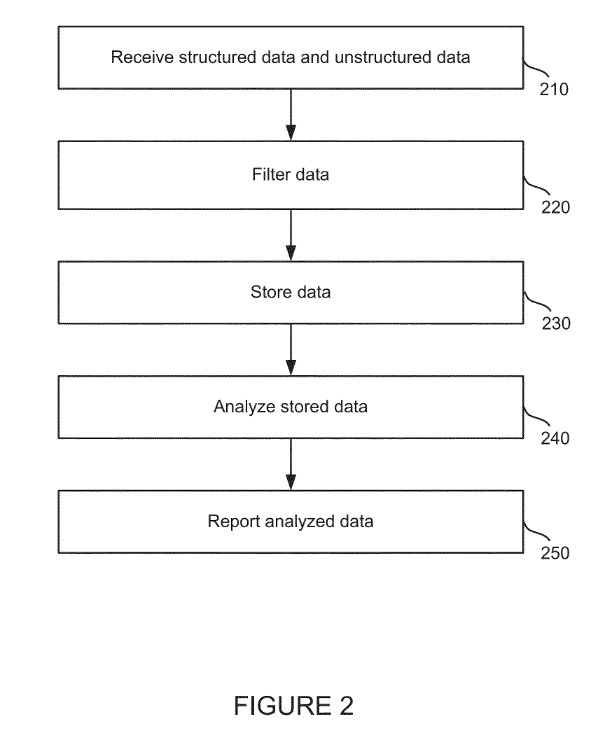

FIG. 2 is a method for analyzing and reporting data. The method of FIG. 2 may be performed by the system of FIG. 1. First, structured data and unstructured data may be received at step 210. The data may be received by filter application 132 on application server 130. The received data may be filtered at step 220. Filter application 132 may filter the data by time sampling, applying intelligence, and other methods to result in a subset of the entire set of the received data.

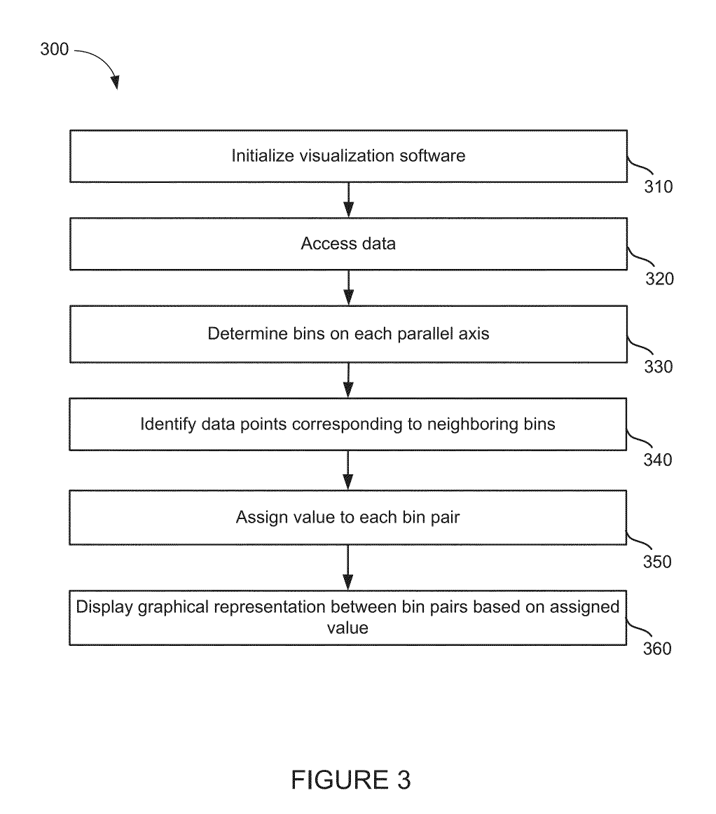

Filtered data may be stored at step 230. The data may be stored based on the type of data it is. For example, structured data may be stored in a SQL database and unstructured data may be stored in a NoSQL database. The stored data may be analyzed at step 240. Analyzing the data may include analyzing the data to detect trends, patterns, or otherwise processing the stored data to determine a subset of data to report to a user. Analyzing the data may be performed by processing application 152 on application server 150. Once the stored data is analyzed, the data can be reported at step 250. The data may be reported through an interactive visualization, reports, or other methods that may be useful to a user. The visualization may present a multi dimensional graph of data and provide an approximation of the data in parallel coordinates. Step 250 is discussed in more detail with respect to FIG. 3.

FIG. 3 is a method for visually approximating data in parallel coordinates. The method of FIG. 3 may provide more detail for step 250 of the method of FIG. 2. In embodiments, visualization application 162 may perform the steps of FIG. 3. The visualization application 162 may extract stored data, mine data for desired information, and provide an interactive visualization of the data.

First, visualization software is initialized at step 310. Initializing the data may include executing the software, identifying what data to retrieve, and other configurations of the software. Data to be visualized may be accessed at step 320. The data may be accessed locally or remotely, for example from data store 140.

Parallel coordinate bins may be determined for each parallel axis at step 330. Each bin may be associated with a range of data. Data points will be placed in a particular coordinate bin if the data point value is within a particular bin's range. The number of bins may depend on the value ranges of the data to be visualized, the desired detail to convey in the visualization, user preference and/or input, and other factors. Once the number of bins is determined, the bin ranges may be selected by dividing the axis length by the number of bins. For example, if an axis were to cover data values ranging from 0 to 1000 units on a screen, and there were 20 bins to display on the axis, each bin would have a range of 50 units. Bins may also have different ranges, if desired. For example, one or more bins for a first parallel axis may have a larger range or narrower range based on the frequency of data values, weighting of bins, and other factors as compared to the number of bins on a second parallel axis.

After bins are determined, data points corresponding to neighboring bins are identified at step 340. Data points may be aggregated into the bins. The values from every data point are used to populate the appropriate bin. For example, if a data point had values of [4, 14, 21], and bins for each parallel coordinate had ranges of 0-9, 10-19, and 20-29, the [0-9] bin count would be incremented for the first coordinate from the [4] value, the [10-19] bin count would be incremented for the second coordinate from the [14] value, and the [20-29] bin count would be incremented for the third coordinate from the [21] value.

After aggregating the data into the bins, a value is assigned to each bin pair at step 350. The value may be the sum of the number of data points that connect each bin pair. For example, bins on an x axis and a y axis may include bins of 1-10 and 11-20, and data points to display may have values of [3,4], [5,5], [2,11], and [4,1]. The bin pair consisting of the 1-10 bin on the x parallel coordinate and the 1-10 bin on the y parallel coordinate would have a value of 3 because three data points would be included in that bin pair. The bin pair consisting of the 1-10 bin on the x parallel coordinate and the 11-20 bin on the y parallel coordinate would have a value of 1 because one data point would be included in that bin pair. In some instances, the value of the bin may represent a number of data points in some other way, for example by normalizing one or more bins.

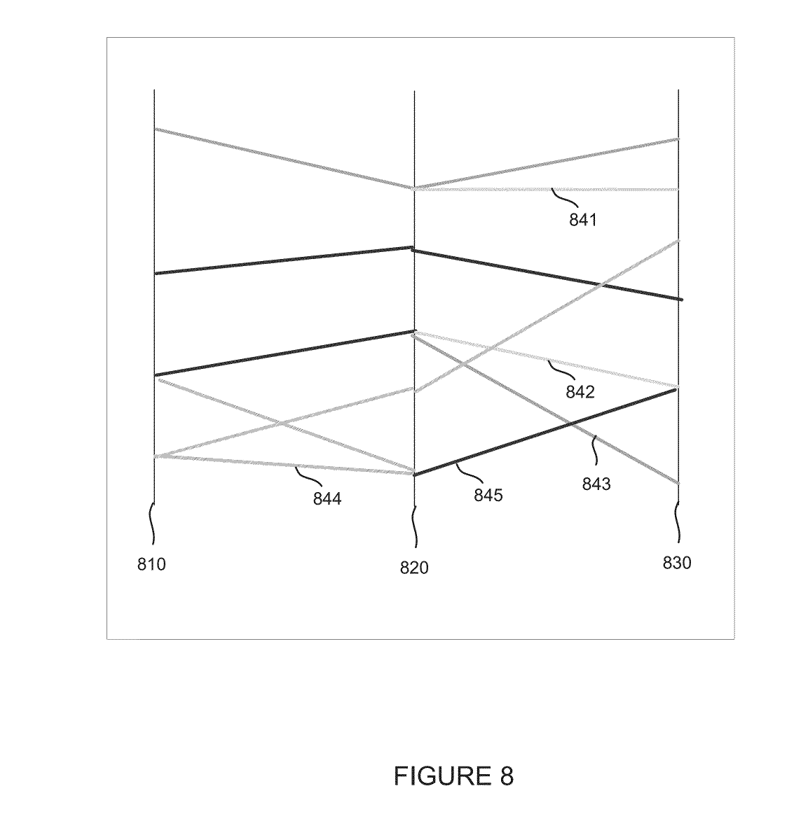

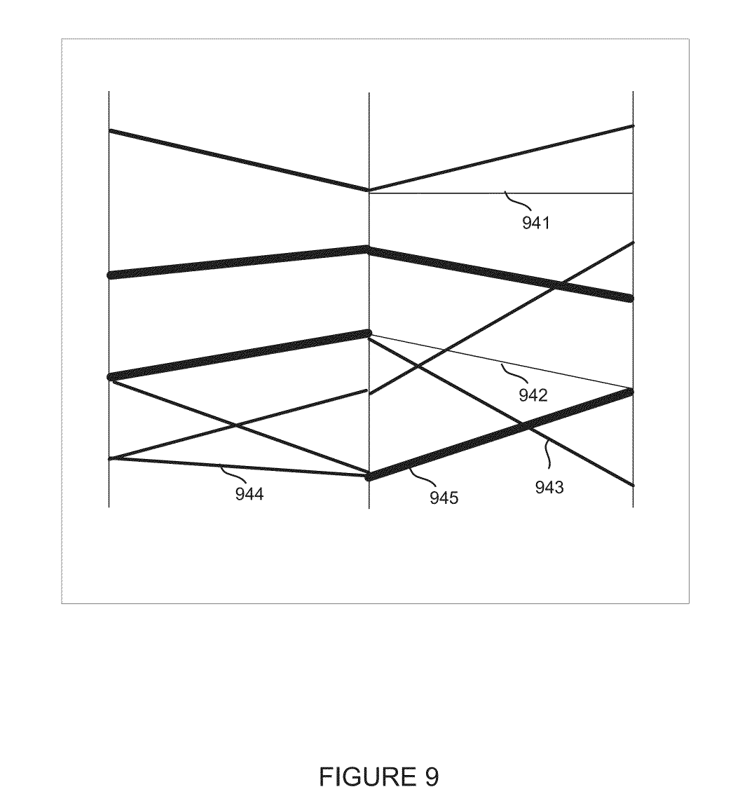

After assigning a value to each bin pair, a graphical representation between bin pairs is displayed at step 360. The graphical representation may be based on the assigned value associated with the bin pair. For example, the graphical representation may be a line between the center point of each bin on the parallel coordinate with the line graphically approximating the volume of data points within that bin. The approximation may include a visual approximation, such as a width of the line, opacity of the line, or other graphical representation. The approximation may also be represented based on color, saturation, and other visual aspects of the line. Examples of parallel coordinate graphical representations that approximate data are illustrated in FIGS. 8 and 9.

In some embodiments, the present technology may also be used with hierarchical bins or groupings. For example, an axis could represent geographical regions and could change to show fewer or more bins/groupings. At the top level it could be all one group, like USA. The user could then drill down to regions, states, counties, and so forth. This and other variations are considered within the scope of the present technology.

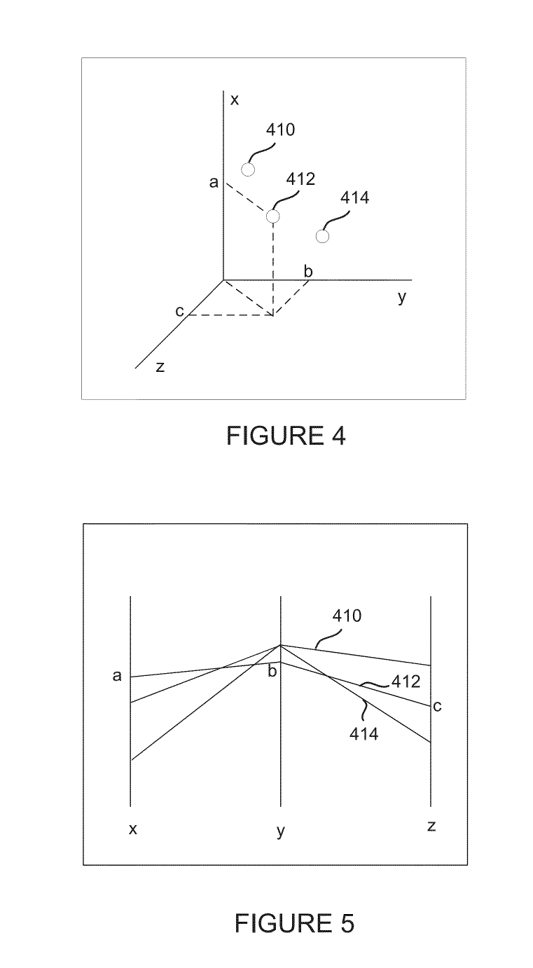

FIGS. 4-9 illustrate examples of a visualization interface for displaying three dimensional data. FIG. 4 illustrates data points in three dimensional x,y,z coordinate system. The interface of FIG. 4 displays an x,y,z graphical coordinate system with data points 410, 412 and 414. Each data point has a value corresponding to each of the x axis, y axis and z axis. For example, data point 412 has an x value of a, a y value of b, and z value of c.

FIG. 5 illustrates data points in parallel coordinates. The parallel coordinates display each data point in the x,y,z coordinate system of FIG. 4 as a set of lines between the three parallel coordinates labeled x, y and z. For example, data point 412 is displayed in the parallel coordinates as having a value of a on the x coordinate, a value of b on the y coordinate, and a value of c on the z coordinate. The parallel coordinates provide a line between the values on the different parallel axes for a data point. For example, there is a line connecting point a on the x axis and point b on the y axis as well as a line between point b on the y axis and point c on the z axis.

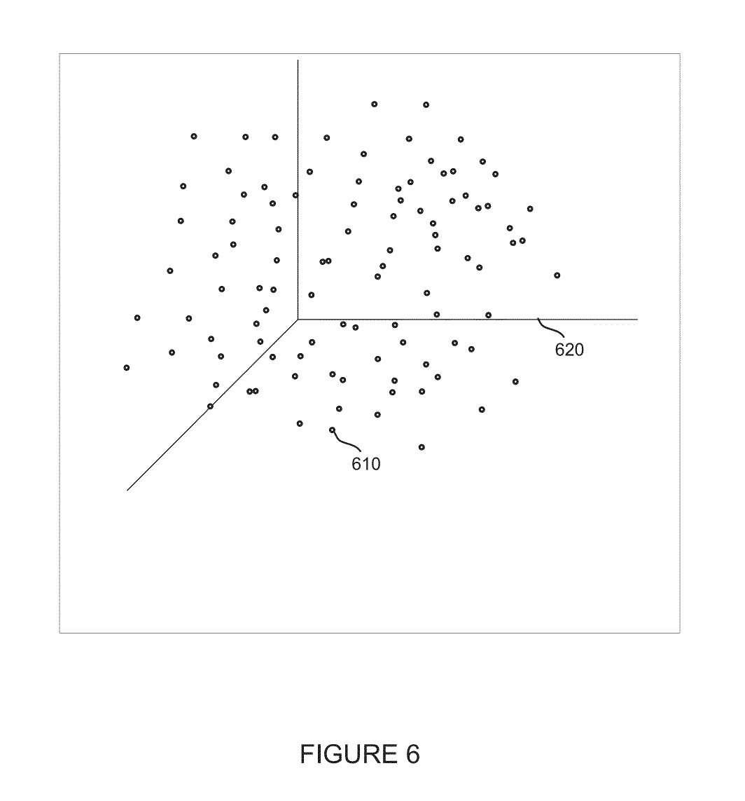

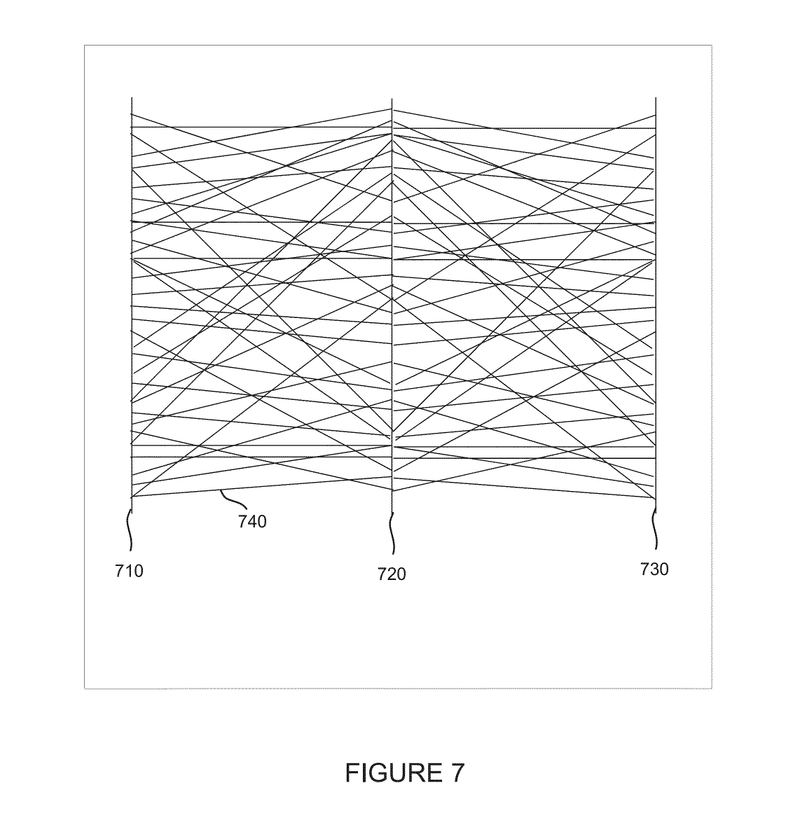

FIG. 6 illustrates a high volume of data points in three dimensional x,y,z coordinate system. Large numbers of data sets can be so complex that it becomes difficult to process using typical database management tools and traditional data processing tools. FIG. 7 illustrates a high volume of data points in parallel coordinates. As shown, when large amounts of data points are displayed in parallel coordinate systems, it can be difficult to parse and process the visualization of the data because the data merely appears as a large number of lines.

FIG. 8 illustrates a first approximation of data points in parallel coordinates. As shown in FIG. 8, the large number of lines in a parallel coordinate system such as that in FIG. 7 (note that the approximation in FIG. 8 is not derived from the data in FIG. 6 or 7) may be represented by a reduced number of lines that approximate the data. Each line between the parallel coordinate axes connects a pair of bins—one bin on each of two axes. In FIG. 8, the opacity of line indicates an approximation of the volume of data points associated with that bin pair. For example, line 841 is lighter in opacity than lines 843 and 845, which indicates that fewer data points correspond to the bin pair associated with line 841. Line 845 is darker than lines 842, 843, and 844, which indicates that more data points are associated with the bin pair for line 845 than for the bin pairs for lines 842, 843, and 844.

FIG. 9 illustrates a second approximation of data points in parallel coordinates. In FIG. 9, the large number of lines in a parallel coordinate system such as that in FIG. 7 (note that the approximation in FIG. 9 is not derived from the data in FIG. 6 or 7) may be represented by a reduced number of lines that approximate the data. Similar to the parallel coordinate display of FIG. 8, each line between the parallel coordinate axis connects a pair of bins, but the width of each line indicates an approximation of the volume of data points associated with that bin pair. For example, line 941 is thinner in width than lines 943 and 945, which indicates that fewer data points correspond to the bin pair associated with line 941. Line 945 is wider than lines 942, 943, and 944, which indicates that more data points are associated with the bin pair for line 945 than for the bin pairs for lines 942, 943, and 944.

Though embodiments may be discussed in terms of bins of data, the present technology may be used with any one or more groups of data. For example, the present technology is applicable to all ways of grouping data (for example, hierarchical groupings like country revenue data that could be drilled-down to state, county, city data).

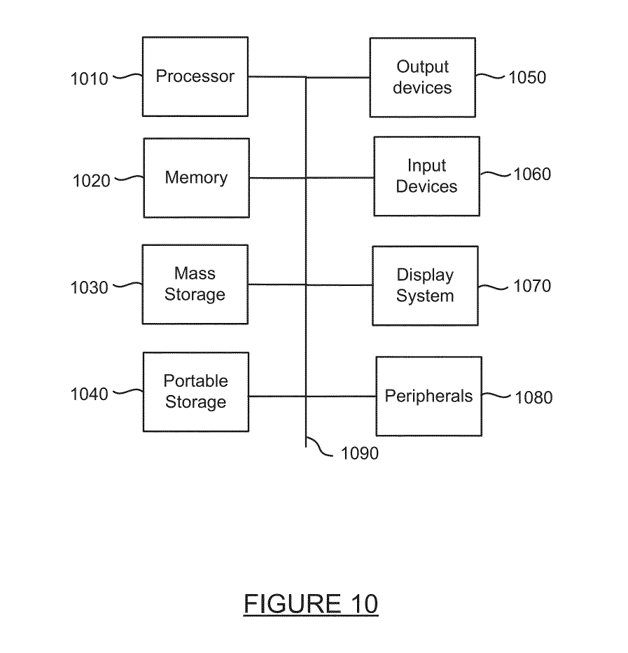

FIG. 10 provides a computing device for implementing the present technology. Computing device 1000 may be used to implement devices such as for example application servers 130, 150 and 160 and data stores 140. The computing system 1000 of FIG. 10 includes one or more processors 1010 and memory 1020. Main memory 1020 stores, in part, instructions and data for execution by processor 1010. Main memory 1020 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components may be connected through one or more data transport means. For example, processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing embodiments of the present invention for purposes of loading that software into main memory 1020.

Portable storage device 1040 operates in conjunction with a portable non-volatile storage medium, such as a floppy disk, compact disk or Digital video disc, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a trackball, stylus, or cursor direction keys. Additionally, the system 1000 as shown in FIG. 10 includes output devices 1050. Examples of suitable output devices include speakers, printers, network interfaces, and monitors.

Display system 1070 may include a liquid crystal display (LCD) or other suitable display device. Display system 1070 receives textual and graphical information, and processes the information for output to the display device.

Peripherals 1080 may include any type of computer support device to add additional functionality to the computer system. For example, peripheral device(s) 1080 may include a modem or a router.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for displaying data, comprising:
determining a number of groups associated with each coordinate in a parallel coordinate display;
identifying a number of data points of a plurality of data points corresponding to a pair of groups in a pair of consecutive coordinates; and
displaying a single graphical representation between each pair of groups that include at least one data point, the single graphical representation based on the volume of data associated with the pair of groups.

2. The method of claim 1, further comprising accessing data records, each record having a plurality of data fields.

3. The method of claim 1, wherein the groups are determined in response to user input.

4. The method of claim 1, wherein each group for a parallel coordinate is associated with a range of values, each data point having a value within a group for each parallel coordinate.

5. The method of claim 1, wherein the single graphical representation between each pair of groups is a line.

6. The method of claim 1, wherein the single graphical representation includes a width that is based on the number of data points within the pair of groups.

7. The method of claim 1, wherein the single graphical representation includes an opacity that is based on the number of data points within the pair of groups.

8. The method of claim 1, wherein the graphical representation is generated by an application for processing large amounts of data.

9. A computer readable storage medium having embodied thereon a program, the program being executable by a processor to perform a method for displaying data, the method comprising:
determining a number of groups associated with each coordinate in a parallel coordinate display;
identifying a number of data points of a plurality of data points corresponding to a pair of groups in a pair of consecutive coordinates; and
displaying a single graphical representation between each pair of groups that include at least one data point, the single graphical representation based on the volume of data associated with the pair of groups.

10. The computer readable storage medium of claim 9, the method further comprising accessing data records, each record having a plurality of data fields.

11. The computer readable storage medium of claim 9, wherein the groups are determined in response to user input.

12. The computer readable storage medium of claim 9, wherein each group for a parallel coordinate is associated with a range of values, each data point having a value within a group for each parallel coordinate.

13. The computer readable storage medium of claim 9, wherein the single graphical representation between each pair of groups is a line.

14. The computer readable storage medium of claim 9, wherein the single graphical representation includes a width that is based on the number of data points within the pair of groups.

15. The computer readable storage medium of claim 9, wherein the single graphical representation includes an opacity that is based on the number of data points within the pair of groups.

16. The computer readable storage medium of claim 9, wherein the graphical representation is generated by an application for processing large amounts of data.

17. A system for displaying data, comprising:
a processor;
memory;
one or more modules stored in memory and executed by the processor to determine a number of groups associated with each coordinate in a parallel coordinate display, identify a number of data points of a plurality of data points corresponding to a pair of groups in a pair of consecutive coordinates, and display a single graphical representation between each pair of groups that include at least one data point, the single graphical representation based on the volume of data associated with the pair of groups.

18. The system of claim 17, the one or more modules further executable to access data records, each record having a plurality of data fields.

19. The system of claim 17, wherein the groups are determined in response to user input.

20. The system of claim 17, wherein each group for a parallel coordinate is associated with a range of values, each data point having a value within a group for each parallel coordinate.

21. The system of claim 17, wherein the single graphical representation between each pair of groups is a line.

22. The system of claim 17, wherein the single graphical representation includes a width that is based on the number of data points within the pair of groups.

23. The system of claim 17, wherein the single graphical representation includes an opacity that is based on the number of data points within the pair of groups.

24. The system of claim 17, wherein the graphical representation is generated by an application for processing large amounts of data.
